(19) United States
(12) Patent Application Publication
(10) Pub. No.: US 2018/0053127 A1
(43) Pub. Date: Feb. 22, 2018

(54) PROJECT AND RESOURCE PLANNING METHODS AND SYSTEMS

(71) Applicant: SOLUFY INFORMATION TECHNOLOGIES, INC., OTTAWA (CA)

(72) Inventor: MARIO BOILEAU, BOURGET (CA)

(21) Appl. No.: 15/545,361

(22) PCT Filed: Jan. 21, 2016
(86) PCT No.: PCT/CA2016/000018

§ 371 Date: Jul. 21, 2017

Related U.S. Application Data
(60) Provisional application No. 62/105,950, filed on Jan. 21, 2015.

(51) Int. Cl. G06Q 10/06; G06F 3/14

(52) U.S. Cl. CPC G06Q 10/0631; G06F 3/14

(57) ABSTRACT

The Kanban process-management approach establishes inventory levels at different stages in manufacturing, standardizes batch sizes and signals production/delivery of a new shipment only as a previous shipment is consumed. However, users viewing Kanban charts whilst able to view tasks by different stages within a process have little comprehension of the timing associated with the tasks individually or as a sequence nor of resource workload and availability. Accordingly, a planning and resource tool allowing disparate project planning methodologies to be combined would allow a user to view not only their tasks within a graphical user interface providing comparable features to the user friendly KanBan format but also to allow them to rapidly visualize the inter-relationship of their tasks with the overall process. Such a tool would allow for quick visual identification of issues relating to their and others workload and availability.

### CROSS-REFERENCE TO RELATED APPLICATIONS

This patent application claims the benefit of World Patent Application PCT/CA2016/000018 filed Jan. 21, 2016 entitled “Project and Resource Planning Methods and Systems” which itself claims priority from U.S. Provisional Patent Application U.S. 62/105,950 filed Jan. 21, 2015 entitled “Project and Resource Planning Methods and Systems.”

### FIELD OF THE INVENTION

This invention relates to project and resource planning and more particularly to methods and systems providing users with improved visualizations of states or flow of the process/project/resources in combination with timing and timeline information.

### BACKGROUND OF THE INVENTION

Project Management is the process and activity of planning, organizing, motivating, and controlling resources, procedures and protocols to achieve specific goals. A project established through Project Management is designed to produce a unique product, service or result with a defined beginning and end (usually time-constrained, and often constrained by funding or deliverables), undertaken to meet unique goals and objectives, typically to bring about beneficial change or added value. Generally projects are temporary in nature in contrast with business as usual (or operations) of an enterprise that are repetitive, permanent, or semi-permanent functional activities to produce products or services. Amongst such operations is manufacturing and its associated Manufacturing Resource Planning (MRP) which are methods for effective planning of resources of a manufacturing enterprise and address operational planning in units, financial planning, and generally have a simulation capability to answer “what-if” questions. In practice, the management of these two aspects of the same enterprise is often quite different, and as such requires the development of distinct technical skills and management strategies directed to each.

A primary challenge of project management is to achieve all of the project goals and objectives while honoring the preconceived constraints which may include scope, time, quality and budget. A secondary challenge is to optimize the allocation of necessary inputs and integrate them to meet pre-defined objectives. Accordingly, project planning typically employs the use of schedules such as Gantt charts to plan and subsequently report progress within a project environment. As such a Gantt chart allows users to create, manage, and visualize the logical dependencies between tasks as well as organize workloads and the management of teams and individuals whilst establishing the critical path to complete the objective.

In contrast an MRP system, which includes so-called MRP2 or MRPII systems, begin with material requirements planning allowing for the input of sales forecasts from sales and marketing. These forecasts determine the raw materials demand and manufacturing requirements based upon yields, timelines, etc. which are then merged with other sales forecasts for the same products or other products to yield a master production schedule. Accordingly, such systems allow the breakdown of specific plans for each product on a line allowing for coordination of raw materials purchasing, development of detailed production schedules that account for machine and labor capacity, as well as scheduling production runs according to the arrival of materials to yield a labor and machine schedule. Over time a variety of MRP systems have evolved, generally from physical implementations, into software implementations where production scheduling is based on the forecast “pushing.” However, since the 1940s a reversal of the thinking wherein MRP addresses a “pull” coming from demand has arisen and evolved into the concepts of lean manufacturing and Just-In-Time (JIT) manufacturing where in these types of production setting, inventory is only pulled through each production center when it is needed to meet a customer's order. The benefits of these methodologies being decreased cycle time, reduced inventory, increased productivity, and increased capital equipment utilization.

Accordingly, Kanban establishes inventory levels at different stages throughout the manufacturing and a signal is sent to produce and deliver a new shipment only as a previous shipment is consumed. Further by standardizing batch sizes at these different stages these signals can not only be tracked to provide visibility of a replenishment cycle, and extraordinary visibility to suppliers and buyers, but to trigger defined work processes within the manufacturing enterprise. However, a user viewing a Kanban chart whilst able to view tasks by different stages within a process has little comprehension of the timing associated with the tasks individually or as a sequence nor of resource workload and availability.

Accordingly, it would be beneficial to provide users with a planning and resource tool that allows these disparate project planning methodologies to be combined allowing a user to view not only their tasks within a graphical user interface providing comparable features to, what is commonly considered user friendly, KanBan format but also to allow them easily and rapidly visualize the inter-relationship of their tasks with the overall process but also identify issues relating to their and others workload and availability.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating project and resource planning and more particularly to methods and systems providing users with improved visualizations of states or flow of the process/project/resources in combination with timing and timeline information.

In accordance with an embodiment of the invention there is provided a method of presenting to a user a graphical user interface (GUI) relating to visualizing tasks relating to a project the user is associated with comprising:
receiving data relating to the tasks from a remote server upon an electronic device comprising a microprocessor and display, the data relating to each task comprising at least an identity of the task, a resource associated with the task, and timing information relating to the task;
receiving an indication of a timeline relating to the portion of the project to be viewed;
generating a first portion of the GUI comprising a plurality of sub-windows and populating tasks within the plurality of sub-windows that have timing information overlapping the timeline, each task having a status that defines the sub-window of the plurality of sub-windows it is to be populated within; and
generating a second portion of the GUI comprising a matrix formed from a plurality of matrix sub-windows and populating tasks within the plurality of matrix sub-windows that have timing information overlapping the timeline, each task having a status that defines either a row or a column within the matrix of matrix sub-windows and timing information that defines the other of the row or the column within the matrix of matrix sub-windows.

In accordance with an embodiment of the invention there is provided a method of presenting tasks to a user through a graphical user interface (GUI) comprising a plurality of regions such that each task is displayable within a first region within a first predetermined subset of regions of the plurality of regions and a second region within a second predetermined subset of regions of the plurality of regions, wherein
the first region within the first predetermined subset of regions of the plurality of regions being established upon a status indicator of the task; and
the second region within the second predetermined subset of regions of the plurality of regions being established upon a status indicator of the task and timing information of the task.

In accordance with an embodiment of the invention there is provided a non-transitory tangible computer readable medium encoding a computer process for execution by a processor, the computer process comprising:
receiving data relating to the tasks from a remote server upon an electronic device comprising a microprocessor and display, the data relating to each task comprising at least an identity of the task, a resource associated with the task, and timing information relating to the task;
receiving an indication of a timeline relating to the portion of the project to be viewed;
generating a first portion of the GUI comprising a plurality of sub-windows and populating tasks within the plurality of sub-windows that have timing information overlapping the timeline, each task having a status that defines the sub-window of the plurality of sub-windows it is to be populated within; and
generating a second portion of the GUI comprising a matrix formed from a plurality of matrix sub-windows and populating tasks within the plurality of matrix sub-windows that have timing information overlapping the timeline, each task having a status that defines either a row or a column within the matrix of matrix sub-windows and timing information that defines the other of the row or the column within the matrix of matrix sub-windows.

In accordance with an embodiment of the invention there is provided a non-transitory tangible computer readable medium encoding a computer process for execution by a processor, the computer process comprising:
generating for presentation to a user upon a display a graphical user interface (GUI) relating to a plurality of tasks, the GUI comprising a plurality of regions such that each task is displayable within a first region within a first predetermined subset of regions of the plurality of regions and a second region within a second predetermined subset of regions of the plurality of regions, wherein
   the first region within the first predetermined subset of regions of the plurality of regions being established upon a status indicator of the task; and
   the second region within the second predetermined subset of regions of the plurality of regions being established upon a status indicator of the task and timing information of the task.

In accordance with an embodiment of the invention there is provided a system comprising:
a display for rendering content within a graphical user interface (GUI) to a user;
a microprocessor in communication with an external network for receiving information relating to the content to be rendered to the user;
a non-transitory tangible computer readable medium encoding a computer process for execution by the microprocessor, wherein
   the computer process receives manufacturing data from a process-management system that organizes the manufacturing data according to a manufacturing sequence associated with the process-management system and re-organizes the manufacturing data to generate the content to be rendered to the user such that it is organized based upon status information and time information within the process-management system relating to a plurality of tasks.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3 depicts an exemplary screenshot of a new planning visualization tool presented to a user according to an embodiment of the invention;

FIG. 4 depicts an exemplary screenshot of a new planning visualization tool presented to a user according to an embodiment of the invention;

FIG. 5 depicts an exemplary screen layout of a new planning visualization tool presented to a user according to an embodiment of the invention;

FIG. 6 depicts an exemplary screen layout of a new planning visualization tool presented to a user according to an embodiment of the invention;

FIG. 7 depicts exemplary new planning tool visualizations of an item for a user according to an embodiment of the invention; and

FIG. 8 depicts exemplary screen layouts of a new planning visualization tool presented to a user according to an embodiment of the invention.

### DETAILED DESCRIPTION

The present invention is directed to project and resource planning and more particularly to methods and systems providing users with improved visualizations of states or flow of the process/project/resources in combination with timing and timeline information.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals whose biometric data may be, but not limited to, monitored, acquired, stored, transmitted, processed and analysed either locally or remotely to the user wherein by their engagement with a service provider, third party provider, enterprise, social network, social media etc. via a dashboard, web service, website, software plug-in, software application, graphical user interface acquires, for example, electronic content. This includes, but is not limited to, private individuals, employees of organizations and/or enterprises, members of community organizations, members of charity organizations, men, women, children, teenagers, and animals. In its broadest sense the user may further include, but not be limited to, software systems, mechanical systems, robotic systems, android systems, etc. that may be characterised by an ability to extract and process content presented and associate to defined actions etc.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” relates to miniature electronic devices that are worn by the user including those under, within, with or on top of clothing and are part of a broader general class of wearable technology which includes “wearable computers” which in contrast are directed to general or special purpose information technologies and media development.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request; said request may be a query, a search, a trigger, an alarm, and a message for example.

Reference to “content information” as used herein may refer to, but is not limited to, any combination of content features, content serving constraints, information derivable from content features or content serving constraints (referred to as “content derived information”), and/or information related to the content (referred to as “content related information”), as well as an extension of such information (e.g., information derived from content related information).

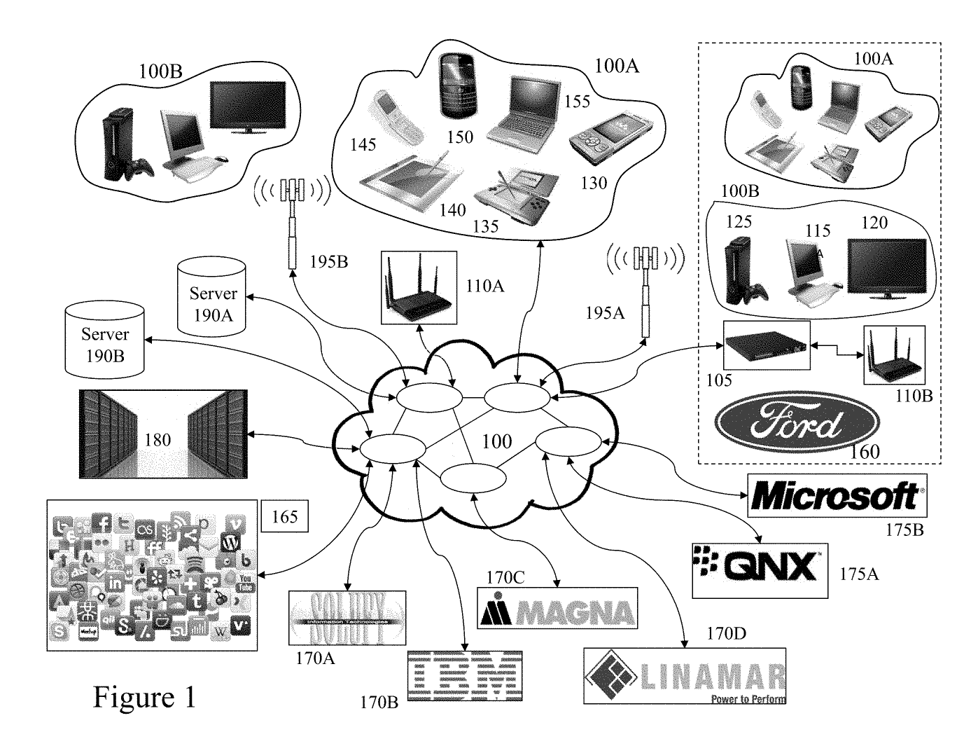

Referring to FIG. 1 there is depicted a network environment 100 within which embodiments of the invention may be employed supporting planning systems and planning applications/platforms (PSPAPs) according to embodiments of the invention. Such PSPAPs, for example supporting multiple channels and dynamic content. As shown first and second user groups 100A and 100B respectively interface to a telecommunications network 100. Within the representative telecommunication architecture a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. Ford™, within which other first and second user groups 100A and 100B are present. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.10, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 100A may form associations either through standards such as IEEE 802.15 and Bluetooth as well in an ad-hoc manner.

Also connected to the network 100 are Social Networks (SOCNETS) 165, first and second software providers 170A and 170B respectively, e.g. Solufy™ and IBM™, first and second suppliers 170C and 170D, e.g. Magna™ and Linamar™, and first to second online service providers 175A and 175B respectively, e.g. QNX™ and Microsoft™, as well as first and second servers 190A and 190B which together with others, not shown for clarity. First and second servers 190A and 190B may host according to embodiments of the inventions multiple services associated with a provider of planning systems and planning applications/platforms (PSPAPs); a provider of a SOCNET or Social Media (SOME) exploiting PSPAP features; a provider of a SOCNET and/or SOME not exploiting PSPAP features; a provider of services to PEDS and/or FEDS; a provider of one or more aspects of wired and/or wireless communications; an Enterprise 160 exploiting PSPAP features; license databases; content databases; image databases; content libraries; customer databases; websites; and software applications for download to or access by FEDs and/or PEDs exploiting and/or hosting PSPAP features. First and second primary content servers 190A and 190B may also host for example other Internet services such as a search engine, financial services, third party applications and other Internet based services.

Accordingly, a user may exploit a PED and/or FED within an Enterprise 160, for example, and access one of the first or second primary content servers 190A and 190B respectively to perform an operation such as accessing/downloading an application which provides PSPAP features according to embodiments of the invention; execute an application already installed providing PSPAP features; execute a web based application providing PSPAP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A.

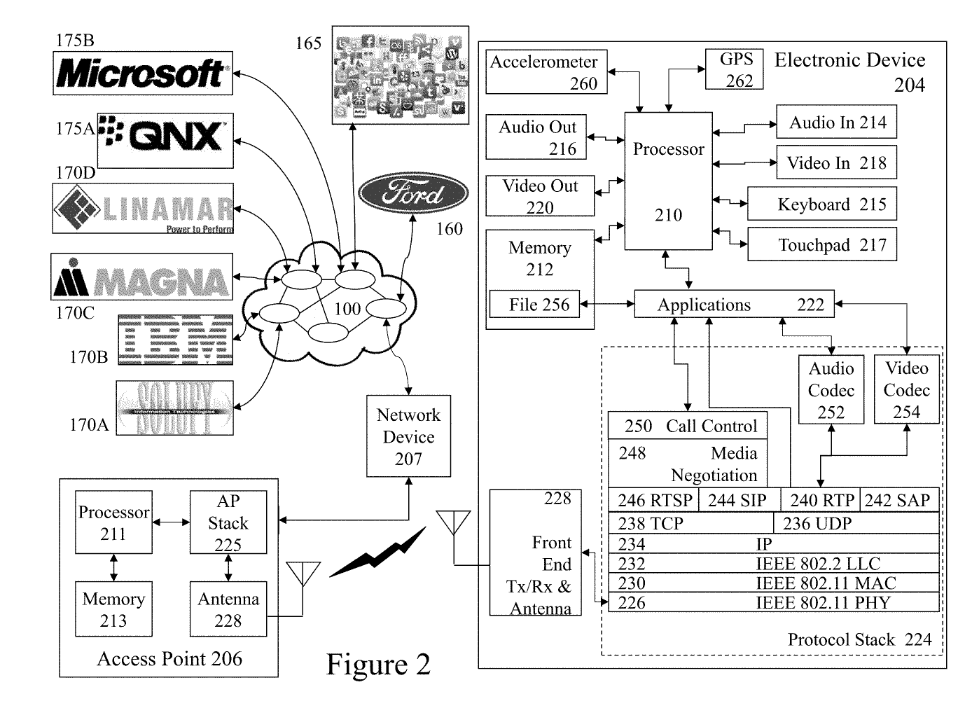

Now referring to FIG. 2 there is depicted an electronic device 204 and network access point 207 supporting PSPAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein Social Networks (SOCNETS) 165, first and second software providers 170A and 170B respectively, e.g. Solufy™ and IBM™, first and second suppliers 170C and 170D, e.g. Magna™ and Linamar™, and first to second online service providers 175A and 175B respectively, e.g. QNX™ and Microsoft™, as well as first and second servers 190A and 190B.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, nonvolatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 21, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.10, IMT-1000, DSL, Dial-Up, DOCSIS, Ethernet, G.hn, ISDN, MoCA, PON, and Power line communication (PLC).

Within the prior art, as discussed above, Gantt charts provide users with a project flow that consists of rows (tasks/activities/projects/sub-projects etc.) with bars associated with them that show on or over what day(s)/time(s) activities are scheduled. When manpower resources are added then these are also displayable or filterable so the user can see only their tasks etc. However, if a task is 5 days long and the user is scheduled as spending 8 hours then assuming 8 hours a day as their standard work pattern they will be shown as 20%, 8 hrs, 1 day etc. in terms of resource across the 5 day task. Similarly, whilst the user will be able to see all the tasks they have been assigned to as a resource the display of these is difficult as a user's tasks may be distributed over several or multiple tasks within tens, hundreds or more of scheduled activities throughout the project. A Gantt chart offers more flexibility, is overall more powerful in handling scheduling, what-if scenarios, re-planning to account for delays, disasters, completion date adjustments etc., and handling larger complex schedules across multiple groups, divisions, and enterprises as well as allowing the project team visibility of the critical path and their tasks that impact it.

In contrast, a KanBan board allows a user to view their tasks with ease as these are organized simply into columns depicting the various states or flow of the process, for example “To Do”, “Planned”, “In Progress”, “QA”, “Done.” However, whilst generally considered easier to use KanBan boards are generally geared towards smaller projects or dealing with a smaller set of tasks at a given point time as otherwise a column or columns can be overcrowded. In some KanBan board software tools within the prior art in order to avoid this the user can limit the number of tasks within each column.

However, against these prior art techniques and their associated software implementations as offered by multiple software vendors either discretely or as part of Enterprise Resource Planning/MRP software suites, the inventor was seeking a visualization tool that allow them to maintain the simplicity and visual appeal of KanBan boards but allowed them to view these within a timeline so that their tasks were within a time based perspective. As noted above within a KanBan board, hereinafter referred to simply as KanBan, is there's no way to know when a task is due, or if someone is not available on a given day or for a given period. For example, is someone on vacation next week or travelling to visit a client next week, such that they will be unable to work on a task or tasks.

Accordingly, the inventor has established a new visualization/planning tool (NEWTOOL) which adds the concept of timelines to elements of KanBan and adds the concepts of time and resource workload/availability to the KanBan concept. These concepts as discussed supra being known within Gantt charts.

According to embodiments of the invention a new planning visualization tool, NEWTOOL, whilst adopting KanBan elements does not necessarily imply the full methodology around KanBan is implement although other embodiments of the invention according to the inventive concept may include the full methodology.

Primarily NEWTOOL according to embodiments of the invention exploits KanBan based layout of the tasks which are organized into columns where each column is associated to a state, status or a group in which that task belongs to. Within the visualization/planning tools of NEWTOOL a user may drag and drop a task from one column to another as the task progresses to another “node” or state of the workflow.

Within embodiments of the invention NEWTOOL has a timeline added to the KanBan board elements in order to specify when a task should be worked on as well as to flag when resources aren't available, have other obligations, and/or are overbooked (workload). Accordingly, users can quickly visualize within NEWTOOL information that would otherwise not be accessible except through the use of a Gantt chart or other planning tool wherein tasks are explicitly associated with resources and resource time/loading information.

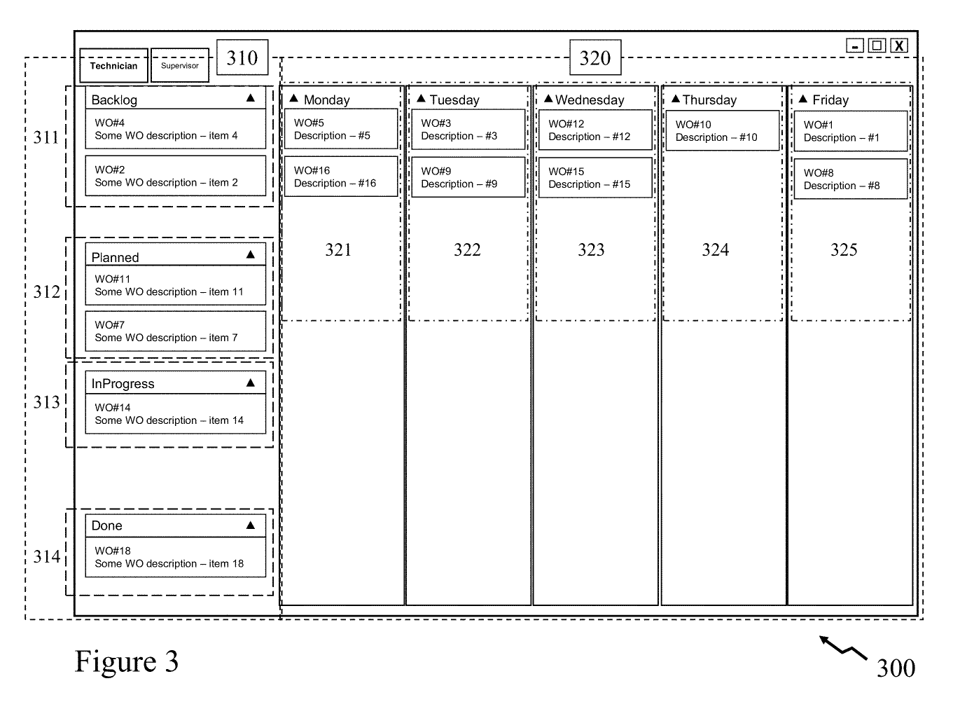

Within the embodiments of the invention described below in respect of FIGS. 3 to 7 exemplary screenshots of NEWTOOL are presented. These include the concept of a daily timeline. However, the concept may be easily adapted and applied to different timebases, including, but not limited to, hourly, weekly, monthly, quarterly, yearly, etc. Equally, a user may adjust the timebase so that they may visualize their tasks and/or task loading over different timebases. This may allow them to provide input with respect to another new project, planning their activities etc. As this timebase displays over longer timelines then NEWTOOL may associate multiple tasks to task groups that have attributes in common, e.g. title, activity, task, etc. or other aspects of the tasks. As such the longer timebases maintain a key visual aspect of simple clear visual presentation. A task group may be selected by the user and expanded as a pop-up screen, for example, that lists the particular tasks grouped into the task group so that if the user is looking for a particular task they may identify it without requiring them to zoom in/out on the timebases and/or pan through time.

It would be evident that NEWTOOL also supports the logic supporting and the concepts of planning and scheduling within Gantt tools and other current planning & scheduling tools, such as Microsoft Project for example, in that activities/tasks that are scheduled to specific dates/time may also have durations attached and are assigned/assignable to people based on their schedule, availability, skill set etc. Accordingly, these can still be applied within NEWTOOL and can also be visualized. For example, as a user moves a task from “In Progress” to “Done” NEWTOOL has this task linked to subsequent tasks such that NEWTOOL automatically moves another task from “Planned” to “To Do” or “In Progress” for example and may also bring other tasks on subsequent linked stages from hidden or out of sight to the user on this current timebase to the “Planned” or “To Do” columns for example. Accordingly, automation of aspects of the KanBan concept may be established through the supporting logic within NEWTOOL exploiting the concepts of planning and scheduling.

Now referring to FIGS. 3 to 7 exemplary screenshots of a NEWTOOL according to embodiments of the invention are displayed. Within each of these the graphical user interface (GUI) is generated and populated based upon existing scheduling data coming from a source planning system such as an ERP, MRP, or project planner for example. Accordingly, whilst NEWTOOL will allow a user to interact with tasks such as move, drag, annotate etc. the tool is primarily intended to address visualization and GUI issues within the prior art rather than provide another tool for entering a series of tasks with their links etc. However, it would be evident that NEWTOOL may be implemented as part of a software suite providing these other elements or that NEWTOOL may be the visualization engine/GUI for an existing planning suite.

In principle a status of a task within MS Project may be interpolated through NEWTOOL to a KanBan status/column. Similarly, a status of a task may be interpolated through NEWTOOL to a KanBan status/column based upon combining data from a project tool and a time management/cost tracking tool. For example, a task may be identified in the plan as being due for work by the user in which case it is within their “To Do” or “Planned” columns for example, but once they add time data to a cost tracking tool or against the task through NEWTOOL then it proceeds to “In Progress” until the user indicates the task is complete e.g. has reached 100%, in which case it proceeds to “Done.” User data within a cost tracking tool may trigger a task into an “In Progress” but typically will not trigger a task into “Done” as the time actually associated by the user in completing the task may different above or below that assigned initially to the task.

Within the exemplary screenshots of FIGS. 3 to 7 the activities, also referred to as tasks or work orders (WOs) are generally populated in their associated column(s) based on their status or where they are in the workflow, or based on any other configurable variables. These activities may also appear in the associated timeline column(s) based on the schedule date(s) associated with them. For simplicity purposes, an activity can appear in either a column of the “workflow” area, or in a column of the timeline area. The “workflow” area is, for example, the set of “state” columns established with respect to the user's activities such as, for example, “Backlog”, “Planned”, “In-Progress”, and “Done”, whilst the timeline area may be a column or columns with weekday captions associated with them. As the timebase is varied “weekday” captions may shift to week identifiers, e.g. Week 5; monthly indicators; quarterly indicators; and yearly indicators.

Within the exemplary screenshots of FIGS. 3 to 7 an item (activity) may appear in both areas or may be associated with one or other area. Optionally, a first section of the GUI may show tasks/activities upon a first timebase, e.g. daily, whilst a second section may depict tasks within a second timebase as the user searches for example.

An item may also have an aspect of its indication to the user varied in dependence upon it's associated state, e.g. its colour may be associated with its status such as pending, to do, in progress, and done, for example, whilst in other embodiments colour may indicate secondary status such as late, early, on-track, or critical, for example. Alternatively, the shape of a task's depiction may vary or alternatively other features such as highlighting, flashing, oscillating, etc. may be employed to highlight particular tasks to a user.

Within embodiments of the invention and item can also appear in multiple timeline columns to specify that it is worked over multiple days (or whatever timebase is currently being employed). Each column, row and cell may have scrollbars associated with it, vertical and/or horizontal, as desired and required. A timebase may be adapted such that, for example, whilst it may normally display 5 days the layout can be adapted to display more or less than 5 days based upon user preferences, system settings, etc. For example, a shift worker working 7 days on-7 days off may be presented with a 7 day window, whilst a worker on 3 days on/2 days off may be presented with 3 day expanded/2 day compressed view.

Optionally, the timebase may adjust according to the number of tasks so that a user with a current high task loading is presented with only a day or 2 days whilst another worker with a single task over an extended period is presented with a longer timebase. The number of columns may therefore be fixed or variable and can display more or less than 5 columns. The timebase currently displayed may be scrolled to future and/or past dates whilst the timebase may be varied to some users or all users.

Within embodiments of the invention special and/or non-project (non-work) items may also appear within the timeline column(s) such as those, for example, relating to vacation time, milestone(s), special notes, etc. As evident from the discussion above with respect to embodiments of the invention the visualization tool/GUI may be geared, generally, towards shorter timeframes, e.g. a day up to a month, it can also be adapted to schedules that span over multiple months as well as, through grouping etc., to large numbers of tasks.

Referring to FIG. 3 there is depicted an exemplary screenshot 300 of a new planning tool's visualization for a user according to an embodiment of the invention. Within this exemplary screenshot 300 relating to a viewed presented to a technician, employee, etc. performing activities there are depicted first and second regions 310 and 320. First region 310 being a representation in vertical format of the KanBan columns such as “Backlog” 311; “Planned” 312; “InProgress” 313; and “Done” 314. Second region 320 depicts tasks to the user based upon timeline as depicted by a standard 5 day working week of columnar information in Monday to Friday 321 to 325 respectively. Within Monday 321, for example, there are depicted first and second tasks 331 and 332 relating to “WO#5—Some WO Description—item 5” and “WO#16—Some WO Description—item 16” respectively. Other days, similarly displaying the tasks associated within the timeline to these days.

Optionally, the first region 310 may be arranged in different configurations, either as standard or through user selection; including but not limited to:
at the top, the right or at the bottom area or a mixture thereof;
arranged horizontally, for example “Backlog” 311 “column” may be to the left of the “Planned” 312 “column”, etc.;
arranged both horizontally and vertically; for example “Backlog” 311 “column” on the left and the other columns vertically on the right.

Within the screenshot 300 the user can drag items/tasks (activities) in a variety of ways, including, but not limited to;
from a state to a day to schedule the work;
from 1 state to the other to change its status/state;
from 1 day to the other to change its scheduled date; and
from a day to a state to change the status/state′ of the task

The tasks may be colour coded to illustrate the overall workload for a given day such that, for example, the header of the day column can be color code and/or the back colour of the item container area can be color coded accordingly. Optionally, the header of the day column can also display the overall workload versus available hours for that day. Where the timeline shifts to weeks, months, etc. then the overall workload versus available hours for the displayed period. Optionally, as the timeline changes from days to weeks/months/etc. then the tasks may change such that they are smaller, e.g. only including summary information, e.g. “WO#5”, or are grouped according to task type, grouped according to task status (e.g. pending, planned, in progress, etc.). Optionally, the user may be presented with a “magnifying glass” overlay so that whilst viewing a compressed timeline, e.g. month, they are able to scroll the timeline “under” the “magnifying glass” which is displayed upon an expanded timeline, e.g. weekly or daily.

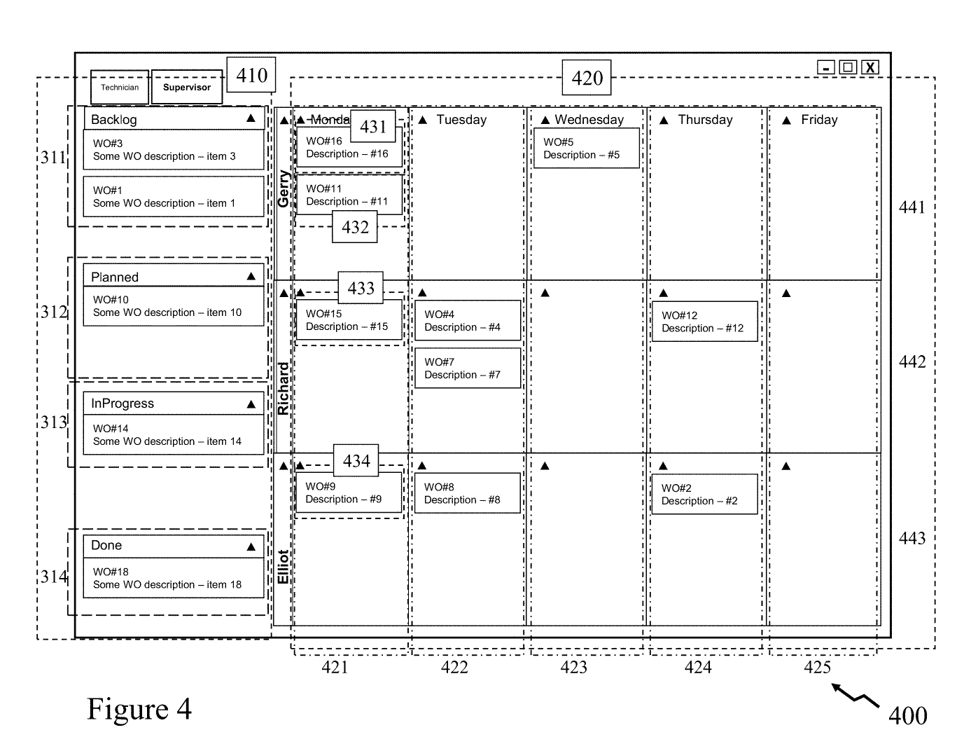

Now referring to FIG. 4 there is depicted an exemplary screenshot 400 of a new planning tool's visualization for a user according to an embodiment of the invention. Within screenshot 400 the NEWTOOL visualization relates to that viewed by a Scheduler or Supervisor type role for assigning activities. Representing the same time period as that within screenshot 300 in FIG. 3 screenshot 400 similarly comprises first and second regions 410 and 420. First region 410 being the representation in vertical format of the KanBan columns such as “Backlog” 311; “Planned” 312; “InProgress” 313; and “Done” 314. Second region 420 however now depicts multiple rows across the timeline as depicted by a standard 5 day working week of columnar information in Monday to Friday 421 to 425 respectively. Each row being associated with a resource in the schedule associated with the tasks(s) displayed within this timeline. Accordingly, within Monday 421, for example, there are depicted first and second tasks 431 and 432 relating to “WO#16—Some WO Description—item 16” and “WO#11—Some WO Description—item 11” respectively for “Gerry”. But also displayed are third task 433 “WO#15—Some WO Description—item 15” associated with “Richard” and “WO#9—Some WO Description—item 9” associated with “Elliot.” Subsequent days, similarly display the tasks associated within the timeline to these days by the employee such that first row 441 displays all tasks associated with “Gerry”, second row 442 displays all tasks associated with “Richard”, and third row 443 displays all tasks associated with “Elliot.” Accordingly, the intersection of a timeline column with a resource row is called a cell, and items in each cell mean they are assigned to that person on that day.

Optionally, screenshot 400 may show only those employees associated with tasks within the displayed timeline or alternatively, the view may show all employees and cells will only be filled with data where the intersection of a task/resource with the timeline occurs. It would be evident that the view presented to the user represented by screenshot 400 may be established based upon one or more rules established by NEWTOOL or through user configuration. For example, resources may be ranked based upon number of tasks within the timeline allowing rapid establishment of loading perspective within the organization, division, project etc. Alternatively, resources may be grouped by team, division, organization, enterprise, etc. and then ranked within each of these groups. Alternatively, only a subset of the resources may be depicted based upon one or more filters applied by NEWTOOL, typically in dependence upon the current view, or through user configuration. Such filters may include, only those resources with backlog, only those resources with scheduled vacation time next week, only resources exceeding or below loading threshold(s), etc.

In this mode/layout, as depicted by screenshot 400, when the user selects/drags an activity to a Timeline/Resource “cell”, then it generally defines (means) that this activity is being assigned to that person on that day. Optionally, the user upon releasing the task within a cell associated with a new resource may be asked whether they wish to transfer fully or add the new resource to the task/activity. In this manner a user can easily add resources or reallocate resources. Optionally, the user upon releasing the task within a cell associated with the same resource may be asked whether they wish to transfer the task fully or extend/amend the period associated with the task/activity. In this manner a user can easily amend timing of activities for resources or reallocate resources by extending activities they have.

Optionally, a “Done” activity could also appear in a Timeline/Resource cell to specify that it was worked on and completed on that day so that the scheduler/supervisor can see what has been completed rather than these not being displayed. Alternatively, these may be “faded” so that whilst visible they do not detract from the cells with current activities, pending activities etc.

Optionally, a Timeline/Resource “cell” may also be of a different colour for various reasons. For example, a resource is on vacation (or not available) on that day. Alternatively, an overloaded resource can be quickly visually highlighted through colour as may one under assigned, etc. Optionally, visual effects can be added to “cells” such that flashing red highlights a late completion of a task with fully loaded or overloaded resources implying high likelihood of additional delay or pending delays in other tasks assigned to those resources.

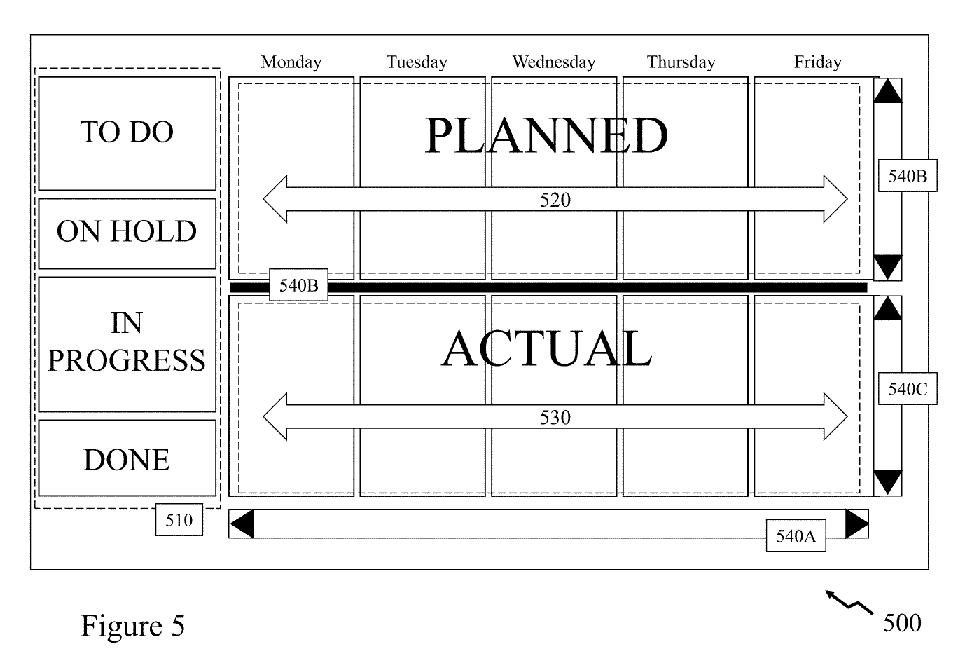

Now referring to FIG. 5 there is depicted an exemplary screenshot 500 of a new planning tool's visualization for a user according to an embodiment of the invention. Within screenshot 500 the NEWTOOL visualization relates to that viewed by a user, for example a resource or supervisor, for example, relating to displaying planned work versus actual work. Accordingly, as depicted the user is presented with first to third regions 510 to 530. First region 510 being in this instance a KanBan board representation in row format of their tasks. The rows presented may be configured by NEWTOOL, the resources supervisor, or by the resource themselves. For example, one resource may wish to only see “To Do” and “In Progress” whilst another may wish to view “On Hold”, “In Progress”, and “Done.”

Second region 520 depicts planned task for the resource over a timeline, in this instance a 5 day standard work week. Third region 530 depicts over the same timeline actual tasks. Through first to third scrollbars 540A to 540C allow for example:
First scrollbar 540A allows the user to scroll through the timeline;
Second scrollbar 540B allows the user to move vertically through all KanBan board stages or a subset of the KanBan board stages; and
Third scrollbar 540C allows the user to move vertically through all KanBan board stages or a subset of the KanBan board stages.

Accordingly, for example, using first and second scrollbars 540A and 540B the user can scroll through time and through “To Do”, “On Hold”, “In Progress” tasks or simply “In Progress” and “To Do” tasks whilst with first and third scrollbars 540A and 540C they can scroll through time and through “Done” tasks. Divider line 545 allows the user to adjust the relative sizing of second and third regions 520 and 530 respectively. Optionally, where multiple KanBan classes are displayed, e.g. “To Do”, “On Hold”, “In Progress” tasks within second window 520, additional divider lines may be selectable by the user to adjust their relative dimensions. Accordingly, the user may exploit the visual simplicity of prior art methodologies such as KanBan boards but within the context of timelines, task associations etc. that cannot be established and utilized within prior art KanBan methodologies.

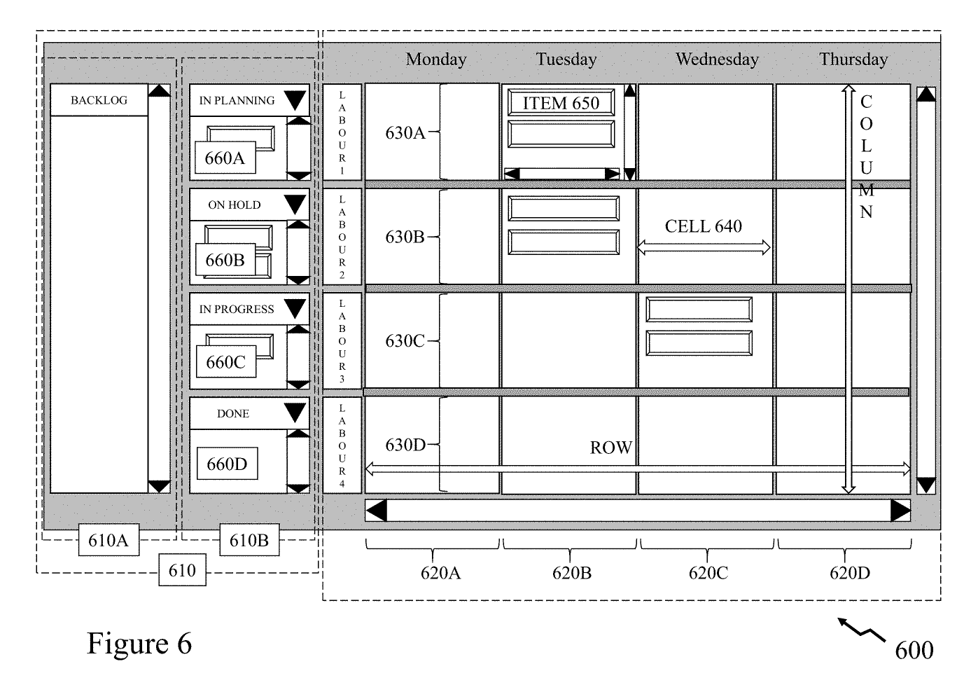

Now referring to FIG. 6 there is depicted an exemplary Display 600 of a new planning tool's visualization for a user according to an embodiment of the invention. Within display 600 the NEWTOOL visualization relates to a high level view of the GUI provided to users. Accordingly, Display 600 depicts/illustrates the different GUI components of our new control/visualization tool established by the inventor. These different GUI components being:
Display 600 is the entire client area of the GUI control;
Display 600 is divided into one or more Areas, e.g. first area 610 and second area 620, although the number of areas may be 1, 2, 3, 4 or more;
Each Area consists of one or more columns, e.g. first and second columns 610A and 610B respectively in first area 610 and first to fourth columns 620A to 620D respectively in second area 620, and 1 or more Rows, first to fourth Rows 630A to 630D respectively; although the number of columns/rows within an area may be 1, 2, 3, 4, etc. or equal numbers of rows/columns or unequal numbers of rows/columns;
The intersection of a column and a row is a Cell 640;
A Cell 640 can contain 1 or more Items 650; and
Each Item 650 can represent a work activity (task) or a non-work and may span across one or more columns of the timeline or appear across multiple rows when rows are associated with resources.

Each Area, Column and Row can be resized using a splitter between it and another element within the Display 600. Optionally, based upon the displayed timeline then an Item 650 may represent a grouping of items in order to reduce visual clutter/confounding.

Each of these components can be scrolled vertically and/or horizontally as desired and as needed. As displayed in Display 600 first column 610A in first area 610 represents a column “Backlog” that spans multiple rows, e.g. “In Planning” 660A, “Planned” 660B, “In Progress” 660C, and “Done” 660D whilst depicted Items 650, whilst second column 610B in first area 610 has each row, e.g. “In Planning” 660A, “Planned” 660B, “In Progress” 660C, and “Done” 660D, delineated with Items 650. According to the content of each cell then these can be internally scrolled where the number of Items 650 exceeds the number displayed. Based upon the number of rows within an area relative to the number of rows displayed then these can similarly scrolled. Based upon the number of rows within a non-timeline area relative to the number of columns displayed then these can similarly scrolled. The columns within a timeline area may also be scrolled to progress forward/backward with respect to the time. In some instances where the columns depicted represent the extent of a resources involvement with the project then this timeline scroll may be disabled, e.g. a resource that is a contractor.

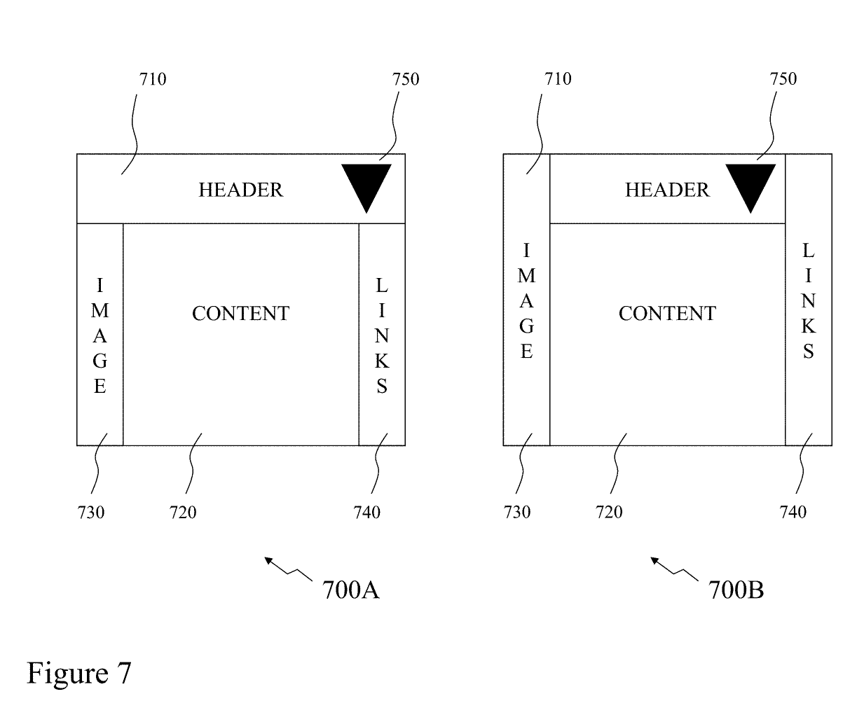

Now referring to FIG. 7 there is depicted exemplary new planning tool visualizations of an item for a user according to an embodiment of the invention. Within screenshot 700 first and second images 700A and 700B relate to high level views of an item, e.g. an Item 650 in FIG. 6, presented to a user within a GUI such as described and depicted in FIGS. 3 to 6 respectively. As depicted each item may have:
A header/title bar 710 identifying the task/activity etc., e.g. “Taurus Bumper”, “WO#12345”, or “iTunes Store Link” etc.;
A content section 720 providing information relating to the task, e.g. “20 Model AA11 Ford Taurus Bumper”, “Call client to resolve defect”, or “Code new screen transition” etc.;
An image list 730, e.g. product to which task relates, image of defect, display mockups, location map to collect items for work, other resources assigned, etc.;
A link list 740, e.g. identifying current slip, delay, from target completion, subsequent task for resource associated with current task etc., such as “Late+1”, “WO#12467” etc.; and
A collapse/expand option 750 wherein this toggles between expanding an item within the view presented or collapses the item within the view.

Optionally, image list 730 and/or link list 740 may be options for the NEWTOOL configuration/supervisor/user to configure according to requirements or preferences. With increased task/item density on GUI these may be automatically suppressed or automatically displayed with reduced task/item density on the GUI. Optionally, the content section 720 may include additional control function for the user or if selected may expand to display a pop-up detailed overview/task outline etc. with or without controls. Optionally, controls relating to the task may be accessed through a right mouse click, for example, yielding a different menu to that of a left click. Left click, may for example trigger pop-up of detailed overview/task outline etc. whilst right click provides access to task modifiers such as “Put On Hold”, “Done”, “Report Problem” etc. Optionally, items may be collapsible under user rather than system control so that only the header is displayed so more items can be displayed at a time.

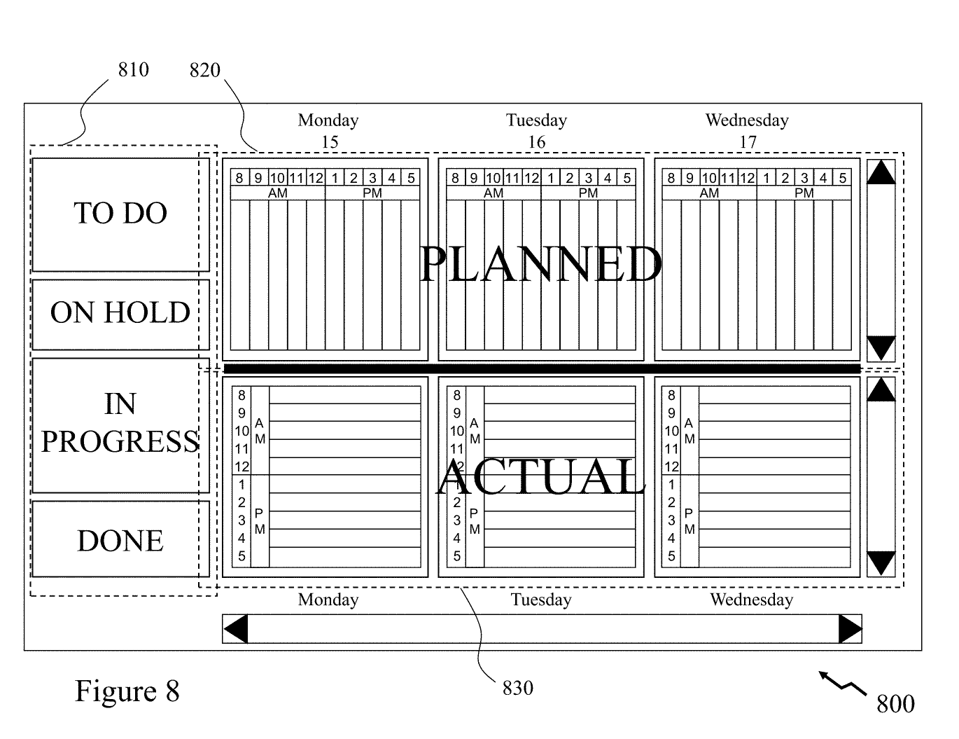

Now referring to FIG. 8 there is depicted an exemplary screenshot 800 of a new planning tool's visualization for a user according to an embodiment of the invention. Within screenshot 800 the NEWTOOL visualization relates to that viewed by a user, for example a resource or supervisor, for example, relating to displaying planned work versus actual work. In overall structure screenshot 800 is similar to screenshot 500 in FIG. 3. Accordingly, as depicted the user is presented with data within three regions. The first left most region 810 being a KanBan board representation in row format of their tasks within this instance. The rows presented may be configured by NEWTOOL, the resources supervisor, or by the resource themselves and within this example are “To Do”, “On Hold”, “In Progress”, and “Done.” Second region 820 depicts planned task for the resource over a timeline, in this instance a 3-day period. Third region 830 depicts the same timeline but now plots actual tasks. Also depicted are scrollbars allowing the user to scroll forward/backwards through the timeline and to scroll vertically through all KanBan board stages or a subset of the KanBan board stages.

Second region 820 is depicted as being for each day of the 3-day period sub-divided into hours horizontally for 5 am-5 pm. This may, for example, be the standard scheduled working period per day for the enterprise or other organization exploiting the NEWTOOL visualization tool or it may represent a portion of the working period per day. In this later instance an additional scroll bar may allow the user to shift the displayed time period per day, e.g. 5 am-3 pm or noon-10 pm for example, allowing activities planned, for example, by one shift may be visualized or an overlap between two shifts for example. Optionally, the number of work days, the number of hours per work day etc. may be user selected or programmed as defaults by administrators etc. Hence, a shift supervisor on an early shift may be presented with only their shift per day whilst a night shift supervisor may be presented only with the period for their shift.

In third region 830 the actual rather than planned tasks are displayed but in this instance the user's viewpoint is one where activities are displayed with a vertical time dependence such that an actual task at 8 am is towards the top of the third region 830 whilst one at 4 pm is towards the bottom of the third region 830. It would be evident that the user may again be able to set the number of hours per work day, number of work days, etc. or these may be set by an administrator for example. In most instances, second and third regions would be displayed to a user with either horizontal time dependency within the work day or with vertical time dependency through the work day etc. However, in some instances the user may have them set differently according to personal preferences. Further, in other instances the time periods may be hours rather than days and the sub-divisions some predetermined or user set sub-divisions of an hour, e.g. every quarter of an hour. Equally, the granularity may be reduced such that rather than a 3-day or 5-day period the timeline is a month, a quarter, a year etc. and then the sub-divisions scale accordingly up into weeks, months etc. In doing so data is accumulated for display within these sub-divisions such that whilst second region 520 may depict a “Planned” activity within the KanBan board representation of one task at the hourly level these are then depicted as the total number within the reduced scale, e.g. 10 for a day representing the number within the 10 hour manufacturing timeline. This may then become 50 for a 5-day week of 10 hours per day etc. Accordingly, a user may rapidly review at multiple levels of timeline granularity as well as having the VIEWTOOL visualization adapted to display timing temporal sub-divisions in a manner appropriate to the user. Hence, a user may find viewing planned tasks as a horizontally based timeline appropriate as they can see issues/impacts etc. relating to shifts as well as total manpower etc. However, the actual work is simply listed temporally. It would be further evident that the timeline/granularity of the second and third regions 820 and 830 can be different such that, for example, second region 820 is as displayed in FIG. 8 with 3-days and hourly sub-divisions but third region 830 may be simply the day.

Within the embodiments of the invention described and depicted supra in respect of FIGS. 1 through 8 a resource has typically been described and discussed in respect of being an individual or a group, etc. of people. However, it would be evident that scheduling tasks, downtimes, maintenance, etc. may also be performed with respect to manufacturing equipment, manufacturing infrastructure etc. without departing from the scope of the invention.

Within the embodiments of the invention described and depicted above in respect of FIGS. 1 to 8 a user has been presented as accessing a task visualization tool, referred to as NEWTOOL, which is provided to the user through one or more planning systems and planning applications/platforms (PSPAPs). It would be evident that a user may access the PSPAP Task Visualization Tool (TAVIT) through one or more PEDs and/or FEDs according to their location, accessible electronic devices, etc. For example, a user may access the TAVIT at home on their personal PED/FED, at their office on their work PED/FED, on a manufacturing floor through terminal functionality integrated within an item of manufacturing equipment (which itself may be a resource), or in other situations such as centralized reporting stations, muster points, workstations etc. Accordingly, the tasks within a project accessed by a plurality of human resources may be accessed through a variety of PEDs/FEDs, upon one or more networks, locally or remotely, within or external to the project authority enterprise etc. For example, using the examples presented in FIGS. 1 and 2 a project established within a PSPAP TAVIT by Enterprise 160, e.g. Ford™, may be accessed by first and second user groups 100A and 100B connected to a network of the Enterprise 160. Other first and second user groups 100A and 100B may be connected to the PSPAP TAVIT established and maintained by Enterprise 160 remotely through Network 100. Alternatively, other first and second user groups 100A and 100B such as, for example, associated with first supplier 170C Magna™ or first online service providers 175A, e.g. QNX™, may also access the PSPAP TAVIT established and maintained by Enterprise 160, as they have tasks/activities that may be driven by tasks/activities of Enterprise 160 or their tasks/activities drive tasks/activities within Enterprise 160.

It would be evident that techniques as known in the prior art for partitioning user access to that they are authorised to view may be similarly implemented within the PSPAP TAVIT such that, for example, first supplier 170C Magna™, may view the PSPAP TAVIT and be shown all tasks/activities to which they/their employees/their operations are a resource. Optionally, they may also be able to view the task/activity preceding/succeeding their task/activity allowing them increased visibility of what drives their tasks and then what drives from their tasks.

Within other embodiments of the invention the PSPAP TAVIT may provide a visualization engine as a discrete software application apart from the main task visualization tool, NEWTOOL described and discussed supra. The discrete task visualization software application (TAVISA) may, for example, provide resources with the ability to view tasks/activities etc. and enter data impacting them such as indicating “Done”, “In Progress” etc. Accordingly, the TAVISA may be a plug-in to other software applications including, but not limited to, electronic mail (e.g. Microsoft™ Outlook, Google™ Mail, Yahoo™ Mail, etc.), word processing software (e.g. OpenOffice, Microsoft™ Word, Corel™ WordPerfect™ etc.), web browser (e.g. Internet Explorer, Firefox™ etc.), or a SOCNET such as Facebook™ or LinkedIn™ for example. In this manner, a geographically distributed team may access a PSPAP TAVIT via a TAVISA through a web interface such as a browser or SOCNET, receive it for review via email for example, and in addition to working with it directly employ it within other applications such as provider internal reviews etc. For example, Magna™ may have a task from Ford™ of producing “20 Model AA11 Ford Taurus Bumper” wherein this is a new design with new tooling for Magna™ and accordingly within Magna™ there is a project for this specifically. Accordingly, the overall fit of the Magna™ development within the release of a new vehicle may be presented to the Magna™ team as they can see the feeds to/from Ford™.

Optionally, within other embodiments of the invention the tasks/activities established by one project, e.g. “Model AA11 Ford Taurus Bumper” may be part of a larger project, e.g. “2015 Ford Taurus”, which is itself part of an overall company project/objective of “All Electric 2015.” Accordingly, Ford™ may access and embed the Magna™ project as a sub-project and view the tasks/activities but be blocked due to authorisation(s) from editing/adjusting/interacting with the embedded sub-project. The merging of such projects may be implemented using one or more techniques as known within the art.

Within the embodiments of the invention presented supra in respect of FIGS. 1 to 8 GUIs supporting PSPAP TAVIT and TAVISA have been presented with particular orientations of GUI elements, e.g. within particular rows or columns within the GUI. However, it would be evident that alternately rows and columns as described may be interchanged either by default or in order to provide a GUI responsive to user preferences, PED/FED display characteristics, etc. It would evident that other visualizations may be provided to the user without departing from the scope of the invention. For example, rather than a scrollable timeline days/weeks/months etc. may be represented as flippable pages to the user or as a three-dimensional matrix or another format appropriate to the content being displayed to the user.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of presenting to a user a graphical user interface (GUI) relating to visualizing tasks relating to a project the user is associated with comprising:
receiving data relating to the tasks from a remote server upon an electronic device comprising a microprocessor and display, the data relating to each task comprising at least an identity of the task, a resource associated with the task, and timing information relating to the task;
receiving an indication of a timeline relating to the portion of the project to be viewed;
generating a first portion of the GUI comprising a plurality of sub-windows and populating tasks within the plurality of sub-windows that have timing information overlapping the timeline, each task having a status that defines the sub-window of the plurality of sub-windows it is to be populated within; and
generating a second portion of the GUI comprising a matrix formed from a plurality of matrix sub-windows and populating tasks within the plurality of matrix sub-windows that have timing information overlapping the timeline, each task having a status that defines either a row or a column within the matrix of matrix sub-windows and timing information that defines the other of the row or the column within the matrix of matrix sub-windows.

2. The method according to claim 1, wherein
the status associated with each task is a status from a KanBan board.

3. The method according to claim 1, wherein
timing information is at least one an hour, day, number of days, week, number of weeks, month, number of months, a quarter, and a reporting period of an enterprise to which the project relates.

4. A method of presenting tasks to a user through a graphical user interface (GUI) comprising a plurality of regions such that each task is displayable within a first region within a first predetermined subset of regions of the plurality of regions and a second region within a second predetermined subset of regions of the plurality of regions, wherein
the first region within the first predetermined subset of regions of the plurality of regions being established upon a status indicator of the task; and
the second region within the second predetermined subset of regions of the plurality of regions being established upon a status indicator of the task and timing information of the task.

5. The method according to claim 4, wherein
the first predetermined subset of regions of the plurality of regions are arranged as at least one of a column, a row, and a table.

6. The method according to claim 4, wherein
the second predetermined subset of regions of the plurality of regions are arranged as at least one of a table and a plurality of tables;
the status indicator defines one of a row or a column within the table or a table within the plurality of tables;
the timing information defines the other of the row or the column within the table or a table within the plurality of tables.

7. The method according to claim 6, wherein
the timing information defines the table within the plurality of tables.

8. A non-transitory tangible computer readable medium encoding a computer process for execution by a processor, the computer process comprising:
receiving data relating to the tasks from a remote server upon an electronic device comprising a microprocessor and display, the data relating to each task comprising at least an identity of the task, a resource associated with the task, and timing information relating to the task;
receiving an indication of a timeline relating to the portion of the project to be viewed;
generating a first portion of the GUI comprising a plurality of sub-windows and populating tasks within the plurality of sub-windows that have timing information overlapping the timeline, each task having a status that defines the sub-window of the plurality of sub-windows it is to be populated within; and
generating a second portion of the GUI comprising a matrix formed from a plurality of matrix sub-windows and populating tasks within the plurality of matrix sub-windows that have timing information overlapping the timeline, each task having a status that defines either a row or a column within the matrix of matrix sub-windows and timing information that defines the other of the row or the column within the matrix of matrix sub-windows.

9. The non-transitory tangible computer readable medium encoding a computer process for execution by a processor according to claim 8, wherein
the status associated with each task is a status from a KanBan board.

10. The non-transitory tangible computer readable medium encoding a computer process for execution by a processor according to claim 8, wherein
timing information is at least one an hour, day, number of days, week, number of weeks, month, number of months, a quarter, and a reporting period of an enterprise to which the project relates.

11. A non-transitory tangible computer readable medium encoding a computer process for execution by a processor, the computer process comprising:
generating for presentation to a user upon a display a graphical user interface (GUI) relating to a plurality of tasks, the GUI comprising a plurality of regions such that each task is displayable within a first region within a first predetermined subset of regions of the plurality of regions and a second region within a second predetermined subset of regions of the plurality of regions, wherein
the first region within the first predetermined subset of regions of the plurality of regions being established upon a status indicator of the task; and
the second region within the second predetermined subset of regions of the plurality of regions being established upon a status indicator of the task and timing information of the task.

12. The non-transitory tangible computer readable medium encoding a computer process for execution by a processor according to claim 11, wherein
the first predetermined subset of regions of the plurality of regions are arranged as at least one of a column, a row, and a table.

13. The non-transitory tangible computer readable medium encoding a computer process for execution by a processor according to claim 11, wherein
the second predetermined subset of regions of the plurality of regions are arranged as at least one of a table and a plurality of tables;
the status indicator defines one of a row or a column within the table or a table within the plurality of tables;
the timing information defines the other of the row or the column within the table or a table within the plurality of tables.

14. The non-transitory tangible computer readable medium encoding a computer process for execution by a processor according to claim 11, wherein
the timing information defines the table within the plurality of tables.

15. A system comprising:
a display for rendering content within a graphical user interface (GUI) to a user;
a microprocessor in communication with an external network for receiving information relating to the content to be rendered to the user;
a non-transitory tangible computer readable medium encoding a computer process for execution by the microprocessor, wherein
the computer process receives manufacturing data from a process-management system that organizes the manufacturing data according to a manufacturing sequence associated with the process-management system and re-organizes the manufacturing data to generate the content to be rendered to the user such that it is organized based upon status information and time information within the process-management system relating to a plurality of tasks.

16. The system according to claim 15, wherein
the content to be rendered to the user within the GUI to the user comprises a plurality of sub-windows defining a timeline wherein the plurality of sub-windows are populated with those tasks within the plurality of tasks that have timing overlapping the timeline, each task having a status within the status information and timing within the time information.

17. The system according to claim 15, wherein
the content to be rendered to the user within the GUI to the user comprises a matrix formed from a plurality of matrix sub-windows defined with respect to a timeline wherein tasks within the plurality of tasks that have timing overlapping the timeline are populated into the plurality of matrix sub-windows, wherein for each task its status within the status information defines either a row or a column within the matrix of matrix sub-windows and its timing within the timing information defines the other of the row or the column within the matrix of matrix sub-windows.
